(19) United States
(12) Patent Application Publication
(10) Pub. No.: US 2017/0042151 A1
(43) Pub. Date: Feb. 16, 2017

(54) SAFENED HERBICIDAL COMPOSITIONS COMPRISING PYRIDINE CARBOXYLIC ACIDS

(71) Applicant: Dow AgroSciences LLC, Indianapolis, IN (US)

(72) Inventors: Norbert M. Satchivi, Carmel, IN (US); Paul R. Schmitzer, Indianapolis, IN (US)

(21) Appl. No.: 15/230,560

(22) Filed: Aug. 8, 2016

Related U.S. Application Data
(60) Provisional application No. 62/203,168, filed on Aug. 10, 2015.

(51) Int. Cl. A01N 43/40; A01N 37/20; A01N 43/56; A01N 43/653; A01N 43/54; A01N 43/80; A01N 43/84; A01N 37/44

(52) U.S. Cl. CPC A01N 43/40; A01N 43/84; A01N 37/20; A01N 37/44; A01N 43/653; A01N 43/54; A01N 43/80; A01N 43/56

(57) ABSTRACT

Disclosed herein are methods of controlling undesirable vegetation, comprising applying to vegetation or an area adjacent to the vegetation or applying to soil or water to limit the emergence or growth of vegetation a safened herbicidal composition comprising a pyridine carboxylic acid herbicide and a safener. Also disclosed herein are compositions for controlling undesirable vegetation in cereals.

### CROSS REFERENCE TO RELATED APPLICATIONS

This application claims the benefit of priority to U.S. Provisional Application No. 62/203,168, filed Aug. 10, 2015, which is incorporated herein by reference in its entirety.

### FIELD OF THE DISCLOSURE

The disclosure is directed to safened herbicidal compositions comprising pyridine carboxylic acids and agriculturally acceptable salts and esters thereof and to methods of controlling undesirable vegetation using same.

### BACKGROUND

Many recurring problems in agriculture involve controlling the growth of undesirable vegetation that can, for instance, negatively affect the growth of desirable vegetation. To help control undesirable vegetation, researchers have produced a variety of chemicals and chemical formulations effective in controlling such unwanted growth.

In some cases, although a herbicide may be effective in controlling undesirable vegetation, it may also have a phytotoxic effect on a crop and cause injury or even kill the crop. Accordingly, safeners can be provided with the herbicide to limit the phytotoxicity of the herbicidal active ingredient.

### SUMMARY OF THE DISCLOSURE

Disclosed herein is a method of controlling undesirable vegetation, comprising applying to vegetation or an area adjacent to the vegetation or applying to soil or water to limit the emergence or growth of vegetation a herbicidal composition. The herbicidal composition comprises (a) a herbicide comprising a compound of the following structure

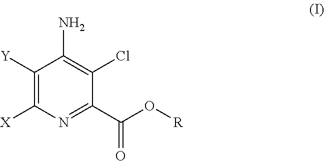

wherein

X represents alkyl, haloalkyl, alkoxy, haloalkoxy, alkylamino, alkenyl, alkynyl or cycloalkyl;

Y represents hydrogen, alkyl, or halogen;

R represents hydrogen, alkyl, or benzyl; or

an agriculturally acceptable salt thereof and

(b) a safener, or an agriculturally acceptable salt or ester thereof;

wherein the safener is benoxacor, 2-CBSU, dichlormid, dicyclonon, fenchlorazole, fenclorim, isoxadifen, mefenpyr-diethyl, naphthalic anhydride, or a combination thereof.

In some embodiments, the herbicide is applied in an amount of at least 4 grams acid equivalent per hectare (g ae/ha) and the undesirable vegetation is controlled in cereal crops. In some embodiments, the cereal crops are spring wheat, winter wheat, durum wheat, spring barley, or a combination thereof. In some embodiments, the undesirable vegetation includes kochia, Canada thistle, wild pansy, lambsquarters, wild mustard, wild chamomile, shepherd's purse, pigweed, or a combination thereof.

In some embodiments, the weight ratio of (a) in g ae/ha to (b) in grams active ingredient per hectare (g ai/ha) is from 1:8 to 2:1, e.g., from 1:4 to 1:1, or about 1:1. In some embodiments, (a) is applied in an amount of from 4-100 g ae/ha. In some embodiments, (b) is applied in an amount of from 5-200 g ai/ha.

Also disclosed herein are compositions for controlling undesirable vegetation in cereals, comprising (a) a herbicide comprising a compound of the following structure

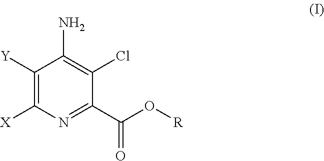

wherein

X represents alkyl, haloalkyl, alkoxy, haloalkoxy, alkylamino, alkenyl, alkynyl or cycloalkyl;

Y represents hydrogen, alkyl, or halogen;

R represents hydrogen, alkyl, or benzyl; or

an agriculturally acceptable salt thereof and

(b) a safener, or an agriculturally acceptable salt or ester thereof;

wherein the safener is benoxacor, 2-CBSU, dichlormid, dicyclonon, fenchlorazole, fenclorim, isoxadifen-ethyl, mefenpyr-diethyl, naphthalic anhydride, or a combination thereof The weight ratio of (a) in g ae/ha to (b) in g ai/ha is from 1:8 to 2:1, e.g., from 1:4 to 1:1, or about 1:1.

The description below sets forth details of one or more embodiment of the present disclosure. Other features, objects, and advantages will be apparent from the description and from the claims.

### DETAILED DESCRIPTION

Disclosed herein is a method of controlling undesirable vegetation, comprising applying to vegetation or an area adjacent to the vegetation or applying to soil or water to limit the emergence or growth of vegetation a herbicidal composition comprising (a) a herbicide comprising a compound of the following structure

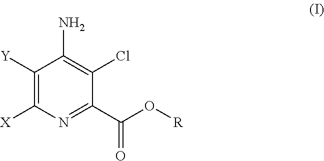

wherein

X represents alkyl, haloalkyl, alkoxy, haloalkoxy, alkylamino, alkenyl, alkynyl or cycloalkyl;

Y represents hydrogen, alkyl, or halogen;

R represents hydrogen, alkyl, or benzyl; or

an agriculturally acceptable salt thereof, and

(b) a safener, or an agriculturally acceptable salt or ester thereof;

wherein the safener is benoxacor, 2-CBSU, dichlormid, dicyclonon, fenchlorazole, fenclorim, isoxadifen, mefenpyr-diethyl, naphthalic anhydride, or a combination thereof.

As used herein, the terms “herbicide” and “herbicidal active ingredient” refer to an active ingredient that kills, controls, or otherwise adversely modifies the growth of vegetation, particularly undesirable vegetation, such as weeds, volunteer crops, and other plant species that differ from the plant species intended for growth, when applied in an appropriate amount. A “herbicidally effective amount” is an amount of an active ingredient that causes a “herbicidal effect,” i.e., an adversely modifying effect and includes deviations from, for instance, natural development, killing, regulation, desiccation, and retardation. The terms “crops” and “vegetation” can include, for instance, germinant seeds, emerging seedlings, and established vegetation.

Pyridine Carboxylic Acid Herbicide

Compositions and methods of the present disclosure can include a pyridine carboxylic acid herbicide comprising a compound of the following structure

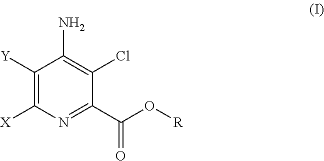

wherein

X represents alkyl, haloalkyl, alkoxy, haloalkoxy, alkylamino, alkenyl, alkynyl or cycloalkyl;

Y represents hydrogen, alkyl, or halogen;

R represents hydrogen, alkyl, or benzyl; or

an agriculturally acceptable salt thereof.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valences of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

“Z¹,” “Z²,” “Z³,” and “Z⁴” are used herein as generic symbols to represent various specific substituents. These symbols can be any substituent, not limited to those disclosed herein, and when they are defined to be certain substituents in one instance, they can, in another instance, be defined as some other substituents. The term “alkyl” as used herein is a branched or unbranched saturated hydrocarbon group of 1 to 24 carbon atoms, such as methyl, ethyl, n-propyl, isopropyl, n-butyl, isobutyl, tert-butyl, pentyl, hexyl, heptyl, octyl, nonyl, decyl, dodecyl, tetradecyl, hexadecyl, eicosyl, tetracosyl, and the like. The alkyl group can also be substituted or unsubstituted. The alkyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfonyl, sulfone, sulfoxide, or thiol, as described below.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” or “haloalkyl” specifically refers to an alkyl group that is substituted with one or more halides, e.g., fluorine, chlorine, bromine, or iodine. The term “alkylamino” specifically refers to an alkyl group that is substituted with one or more amino groups, as described below, and the like. When “alkyl” is used in one instance and a specific term such as “hydroxyalkyl” is used in another, it is not meant to imply that the term “alkyl” does not also refer to specific terms such as “hydroxyalkyl” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., a “hydroxyalkenyl,” and the like. Again, the practice of using a general term, such as “cycloalkyl,” and a specific term, such as “alkylcycloalkyl,” is not meant to imply that the general term does not also include the specific term.

The term “alkoxy” as used herein is an alkyl group bound through a single, terminal ether linkage; that is, an “alkoxy” group can be defined as —OZ¹ where Z¹ is alkyl as defined above.

The term “haloalkoxy” as used herein is a haloalkyl group bound through a single, terminal ether linkage; that is, a “haloalkoxy” group can be defined as —OZ¹ where Z¹ is haloalkyl as defined above.

The term “alkenyl” as used herein is a hydrocarbon group of from 2 to 24 carbon atoms with a structural formula containing at least one carbon-carbon double bond. Asymmetric structures such as (Z¹Z²)C═C(Z³Z⁴) are intended to include both the E- and Z-isomers. This can be presumed in structural formulae herein wherein an asymmetric alkene is present, or it can be explicitly indicated by the bond symbol C═C. The alkenyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfonyl, sulfone, sulfoxide, or thiol, as described below.

The term “alkynyl” as used herein is a hydrocarbon group of 2 to 24 carbon atoms with a structural formula containing at least one carbon-carbon triple bond. The alkynyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfonyl, sulfone, sulfoxide, or thiol, as described below.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl” is a cycloalkyl group as defined above where at least one of the carbon atoms of the ring is substituted with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, alkoxy, alkenyl, alkynyl, aryl, heteroaryl, aldehyde, amino, carboxylic acid, ester, ether, halide, hydroxy, ketone, nitro, silyl, sulfonyl, sulfone, sulfoxide, or thiol as described herein.

The terms “amine” or “amino” as used herein are represented by the formula —NZ¹Z², where Z¹ and Z² can each be a substituent group as described herein, such as hydrogen, an alkyl, halogenated alkyl, alkenyl, alkynyl, aryl, heteroaryl, cycloalkyl, cycloalkenyl, heterocycloalkyl, or heterocycloalkenyl group described above. “Amido” is —C(O)NZ¹Z².

The term “halide” or “halogen” as used herein refers to fluorine, chlorine, bromine, and iodine. The corresponding term “halo”, e.g., fluoro, chloro, bromo, and iodo as used herein, refers to the corresponding radical or ion.

The term “benzyl” as used herein is a benzene bonded through a CH₂ group; that is, a “benzyl” group can be defined as —CH₂C₆H₅.

In some embodiments of formula I, Y is fluorine and the herbicide has the following structure:

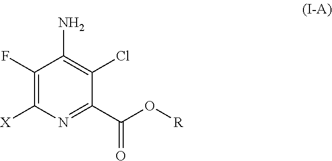

wherein

X represents alkyl, haloalkyl, alkoxy, haloalkoxy, alkylamino, alkenyl, alkynyl or cycloalkyl;

R represents hydrogen, alkyl, or benzyl; or

an agriculturally acceptable salt thereof.

In some embodiments of formula I, R is hydrogen and the herbicide has the following structure:

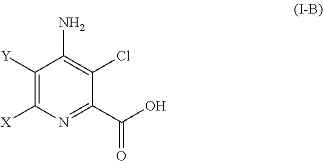

wherein

X represents alkyl, haloalkyl, alkoxy, haloalkoxy, alkylamino, alkenyl, alkynyl or cycloalkyl;

Y represents hydrogen, alkyl, or halogen; or

an agriculturally acceptable salt thereof.

In some embodiments of formula I, X is CR¹R²CH₃ and the herbicide has the following structure:

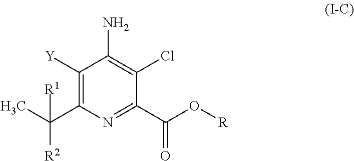

wherein

R¹ and R² independently represent hydrogen or halogen;

Y represents hydrogen, alkyl, or halogen;

R represents hydrogen, alkyl, or benzyl; or

an agriculturally acceptable salt thereof.

In some embodiments of formula I, Y is fluorine, R is hydrogen, and the herbicide has the following structure:

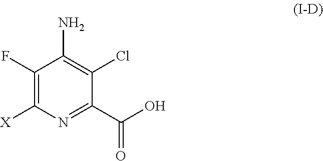

wherein

X represents alkyl, haloalkyl, alkoxy, haloalkoxy, alkylamino, alkenyl, alkynyl or cycloalkyl; or

an agriculturally acceptable salt thereof.

In some embodiments of formula I, Y is fluorine, X is CR¹R²CH₃, and the herbicide has the following structure:

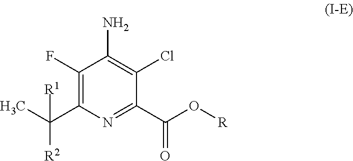

wherein

R¹ and R² independently represent hydrogen or halogen;

R represents hydrogen, alkyl, or benzyl; or

an agriculturally acceptable salt thereof.

In some embodiments of formula I, X is CR¹R²CH₃, R is hydrogen, and the herbicide has the following structure:

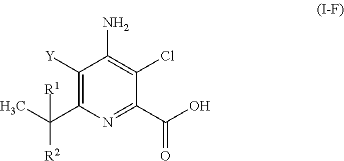

wherein

R¹ and R² independently represent hydrogen or halogen;

Y represents hydrogen, alkyl, or halogen; or

an agriculturally acceptable salt thereof.

In some embodiments of formula I, Y is fluorine, X is CR¹R²CH₃, R is hydrogen, and the herbicide has the following structure:

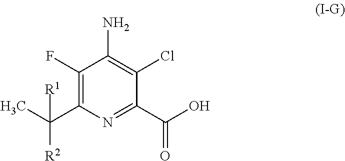

wherein

R¹ and R² independently represent hydrogen or halogen; or

an agriculturally acceptable salt thereof.

In some embodiments of formula I-G, R¹ and R² are both hydrogen, and the herbicide has the following structure:

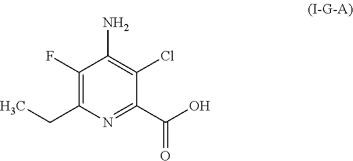

or an agriculturally acceptable salt thereof.

In some embodiments of formula I-G, R¹ is H, R² is F, and the herbicide has the following structure:

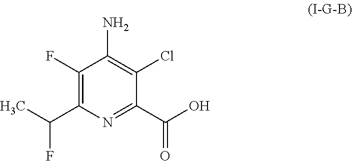

or an agriculturally acceptable salt thereof.

In some embodiments of formula I-G, R¹ and R² are both F, and the herbicide has the following structure:

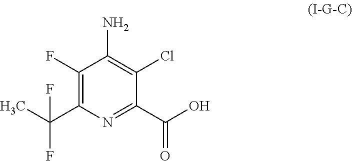 [SMILES: CC(F)(F)c1nc(C(=O)O)c(Cl)c(N)c1F]

or an agriculturally acceptable salt thereof.

In some embodiments, the pyridine carboxylic acid herbicide of formula I can be provided as an agriculturally acceptable salt. Exemplary agriculturally acceptable salts of the pyridine carboxylic acid herbicide of formula I include, but are not limited to, sodium salts, potassium salts, ammonium salts or substituted ammonium salts, in particular mono-, di- and tri-C₁-C₈-alkylammonium salts such as methyl ammonium, dimethylammonium and isopropylammonium, mono-, di- and tri-hydroxy-C₂-C₈-alkylammonium salts such as hydroxyethylammonium, di(hydroxyethyl)ammonium, tri(hydroxyethyl)ammonium, hydroxypropylammonium, di(hydroxypropyl)ammonium and tri(hydroxypropyl)ammonium salts, olamine salts, and diglycolamine salts.

Safeners

Compositions and methods of the present disclosure can include a safener selected from the group consisting of benoxacor, 2-CBSU, dichlormid, dicyclonon, fenchlorazole, fenclorim, isoxadifen-ethyl, mefenpyr-diethyl, naphthalic anhydride, and combinations thereof. Herbicide safeners are molecules used in combination with herbicides to make them “safer”—that is, to reduce the effect of the herbicide on crop plants and to improve selectivity between crop plants and weed species being targeted by the herbicide. Herbicide safeners can be used to pre-treat crop seeds prior to planting or they can be sprayed on plants as a mixture with the herbicide. The safener can be any agriculturally acceptable salt or ester thereof.

In some examples, the compositions and methods of the present disclosure can include benoxacor or agriculturally acceptable salts and esters thereof. Benoxacor is the common name for (±)-4-(dichloroacetyl)-3,4-dihydro-3-methyl-2H-1,4-benzoxazine, also shown in the following structure. Benoxacor's safening activity is described, for example, in The Pesticide Manual, Fifteenth Edition, 2009.

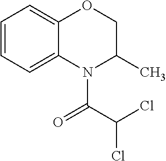 [SMILES: CC1COc2ccccc2N1C(=O)C(Cl)Cl]

In some examples, the compositions and methods of the present disclosure can include 2-CBSU or agriculturally acceptable salts and esters thereof 2-CBSU is the common name for N-(aminocarbonyl)-2-chlorobenzenesulfonamide, also shown in the following structure. 2-CBSU's safening activity is described, for example, in Modern Crop Protection Compounds, 2007.

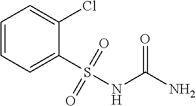 [SMILES: NC(=O)NS(=O)(=O)c1ccccc1Cl]

In some examples, the compositions and methods of the present disclosure can include dichlormid or agriculturally acceptable salts and esters thereof. Dichlormid is the common name for N,N-diallyl-2,2-dichloroacetamide, also shown in the following structure. Dichlormid's safening activity is described, for example, in The Pesticide Manual, Fifteenth Edition, 2009.

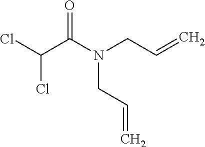

In some examples, the compositions and methods of the present disclosure can include dicyclonon or agriculturally acceptable salts and esters thereof. Dicyclonon is the common name for (RS)-1-dichloroacetyl-3,3,8a-trimethylperhydropyrrolo[1,2-c]pyrimidin-6(2H)-one, also shown in the following structure. Dicyclonon's safening activity is described, for example, in Pesticide Biochemistry and Physiology 1992, 42, 128-139.

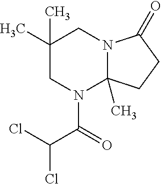 [SMILES: CC1(C)CN2C(=O)CCC2(C)N(C(=O)C(Cl)Cl)C1]

In some examples, the compositions and methods of the present disclosure can include fenchlorazole or agriculturally acceptable salts and esters thereof. Fenchlorazole is the common name for 1-(2,4-dichlorophenyl)-5-(trichloromethyl)-1H-1,2,4-triazole-3-carboxylic acid, also shown in the following structure. Fenchlorazole's safening activity is described, for example, in The Pesticide Manual, Fifteenth Edition, 2009.

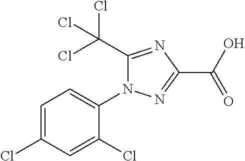 [SMILES: O=C(O)c1nc(C(Cl)(Cl)Cl)n(-c2ccc(Cl)cc2Cl)n1]

In some examples, the compositions and methods of the present disclosure can include fenclorim or agriculturally acceptable salts and esters thereof. Fenclorim is the common name for 4,6-dichloro-2-phenylpyrimidine, also shown in the following structure. Fenclorim's safening activity is described, for example, in The Pesticide Manual, Fifteenth Edition, 2009.

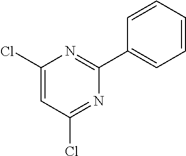 [SMILES: Clc1cc(Cl)nc(-c2ccccc2)n1]

In some examples, the compositions and methods of the present disclosure can include isoxadifen or agriculturally acceptable salts and esters thereof. Isoxadifen is the common name for 5,5-diphenyl-4,5-dihydro-1,2-oxazole-3-carboxylic acid, also shown in the following structure. Isoxadifen's safening activity is described, for example, in The Pesticide Manual, Fifteenth Edition, 2009.

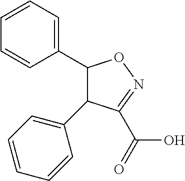 [SMILES: O=C(O)C1=NOC(c2ccccc2)C1c1ccccc1]

In some examples, the compositions and methods of the present disclosure can include isoxadifen-ethyl. Isoxadifen-ethyl is the common name for ethyl 5,5-diphenyl-4,5-dihydro-1,2-oxazole-3-carboxylate, also shown in the following structure. Isoxadifen-ethyl's safening activity is described, for example, in The Pesticide Manual, Fifteenth Edition, 2009.

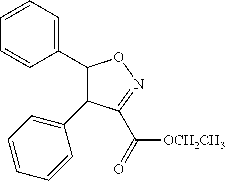 [SMILES: CCOC(=O)C1=NOC(c2ccccc2)C1c1ccccc1]

In some examples, the compositions and methods of the present disclosure can include mefenpyr-diethyl or agriculturally acceptable salts and esters thereof. Mefenpyr-diethyl is the common name for (RS)-1-(2,4-dichlorophenyl)-5-methyl-2-pyrazoline-3,5-dicarboxylate, also shown in the following structure. Mefenpyr-diethyl's safening activity is described, for example, in The Pesticide Manual, Fifteenth Edition, 2009.

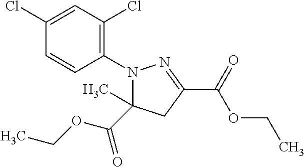 [SMILES: CCOC(=O)C1=NN(c2ccc(Cl)cc2Cl)C(C)(C(=O)OCC)C1]

In some examples, the compositions and methods of the present disclosure can include naphthalic anhydride or agriculturally acceptable salts and esters thereof. Naphthalic anhydride's safening activity is described, for example, in The Pesticide Manual, Fifteenth Edition, 2009.

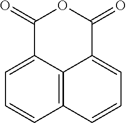 [SMILES: O=C1OC(=O)c2cccc3cccc1c23]

Herbicidal Mixtures or Combinations

The (a) herbicide of formula I or an agriculturally acceptable salt or ester thereof, is mixed with or applied in combination with (b) a safener or an agriculturally acceptable salt or ester thereof.

In some embodiments, the (a) herbicide of formula I or an agriculturally acceptable salt or ester thereof, is mixed with or applied in combination with (b) a safener or an agriculturally acceptable salt or ester thereof in an amount sufficient to induce a synergistic herbicidal effect. In some embodiments, (a) and (b) are used in an amount sufficient to induce a synergistic herbicidal effect while still showing good crop compatibility (i.e. their use in crops does not result in increased damage to crops or reduces damage to crops when compared to the individual application of the herbicidal compounds (a) or (b)). As described in the Herbicide Handbook of the Weed Science Society of America, Tenth Edition, 2014, p. 487, “′synergism′ [is] an interaction of two or more factors such that the effect when combined is greater than the predicted effect based on the response to each factor applied separately.” Synergistic in the herbicide context can mean that the use of (a) and (b) as defined above results in an increased weed control effect compared to the weed control effects that are possible with the use of (a) or (b) alone. In some embodiments, the damage or injury to the undesired vegetation or the crop caused by the compositions and methods disclosed herein is evaluated using a scale from 0% to 100%, when compared with the untreated control vegetation, wherein 0% indicates no damage to the undesired vegetation and 100% indicates complete destruction of the undesired vegetation. In some embodiments, Colby's formula is applied to determine whether using (a) and (b) in combination shows a synergistic effect: S. R. Colby, Calculating Synergistic and Antagonistic Responses of Herbicide Combinations, WEEDS 15, p. 22 (1967)

$$E = X + Y - \frac{X * Y}{100}$$

wherein

X=effect in percent using (a) or an agriculturally acceptable salt or ester thereof at an application rate α;

Y=effect in percent using (b) a safener or an agriculturally acceptable salt or ester thereof at an application rate b;

E=expected effect (in %) of (a)+(b) at application rates a and b.

In Colby's equation, the value E corresponds to the effect (plant damage or injury) that is to be expected if the activity of the individual compounds is additive. If the observed effect is higher than the value E calculated according to the Colby equation, then a synergistic effect is present according to the Colby equation. Likewise, with respect to the desired crop, if the observed effect is lower than the value E calculated according to the Colby equation, then a synergistic effect is present according to the Colby equation with respect to crop safening. In some embodiments, the value for E is greater than X+Y.

In some embodiments, the compositions and methods disclosed herein are synergistic as defined by the Colby equation. In some embodiments, the joint action of herbicide (a) or an agriculturally acceptable salt or ester thereof and (b) a safener or an agriculturally acceptable salt or ester thereof results in enhanced activity against undesired vegetation (via synergism), even at application rates below those typically used for the pesticide to have a herbicidal effect on its own. In some embodiments, the compositions and methods disclosed herein can, based on the individual components, be used at lower application rates to achieve a herbicidal effect comparable to the effect produced by the individual components at normal application rates. In some embodiments, the compositions and methods disclosed herein provide an accelerated action on undesired vegetation (i.e. they effect damaging of undesired vegetation more quickly compared with application of the individual herbicides). In some embodiments, the joint action of herbicide (a) or an agriculturally acceptable salt or ester thereof and (b) a safener or an agriculturally acceptable salt or ester thereof results in reduced activity against desired vegetation/crops (via synergism).

In some embodiments, the observed effect for undesired vegetation is at least 1%, at least 2%, at least 3%, at least 4%, at least 5%, at least 10%, at least 15%, at least 20%, or at least 25% greater than the effect (E) calculated according to the Colby equation (e.g., an observed effect of 96% would be 4% greater than an calculated effect (E) of 92%). In some embodiments, for undesired vegetation, the difference (D_{O}) between 100% and the observed effect is at least 5%, at least 10%, at least 15%, at least 20%, at least 25%, at least 30%, at least 35%, at least 40%, at least 45%, or at least 50% less than the difference (D_{E}) between 100% and the effect (E) calculated according to the Colby equation (e.g., an observed effect of 96% would produce a Do of 4%, a calculated effect (E) of 92% would produce a D_{E} of 8%, and Do would be 50% less than or half of D_{E}). In some embodiments, the observed effect for desired vegetation/crops is at least 1%, at least 2%, at least 3%, at least 4%, at least 5%, at least 6%, at least 7%, at least 8%, at least 9%, or at least 10% less than the effect (E) calculated according to the Colby equation. In some embodiments, for desired vegetation/crops, the difference (Do) between 100% and the observed effect is at least 2%, at least 5%, at least 10%, at least 15%, at least 20%, or at least 25% greater than the difference (D_{E}) between 100% and the effect (E) calculated according to the Colby equation.

In some embodiments, the weight ratio of (a) in g ae/ha to (b) in g ai/ha is at least 1:8 (e.g., at least 1:7.5, at least 1:7, at least 1:6.5, at least 1:6, at least 1:5.5, at least 1:5, at least 1:4.5, at least 1:4, at least 1:3.5, at least 1:3, at least 1:2.5, at least 1:2, at least 1:1.75, at least 1:1.5, at least 1:1.25, at least 1:1, at least 1.25:1, at least 1.5:1, or at least 1.75:1). In some embodiments, the weight ratio of (a) in g ae/ha to (b) in g ai/ha is 2:1 or less (e.g., 1.75:1 or less, 1.5:1 or less, 1.25:1 or less, 1:1 or less, 1:1.25 or less, 1:1.5 or less, 1:1.75 or less, 1:2 or less, 1:2.5 or less, 1:3 or less, 1:3.5 or less, 1:4 or less, 1:4.5 or less, 1:5 or less, 1:5.5 or less, 1:6 or less, 1:6.5 or less, 1:7 or less, or 1:7.5 or less). In some embodiments, the compositions comprise a weight ratio of (a) in g ae/ha to (b) in g ai/ha from about 1:8 to about 2:1 (e.g., from 1:8 to 1:4, from 1:4 to 2:1, from 1:2 to 2:1, from 1:4 to 1:1, from 1:2 to 1:1, or from 1:1 to 2:1). In some embodiments, (a) and (b) are applied in a weight ratio of (a) in g ae/ha to (b) in g ai/ha of about 1:1. In some embodiments, the active ingredients consist of (a) and (b). In some embodiments, the composition does not include a herbicidal active ingredient in addition to (a), i.e., the herbicidal active ingredient consists of (a), wherein (b) is classified as a safener. In some embodiments, the composition does not include a safener in addition to (b), i.e., the safener consists of (b).

Formulations

The present disclosure also relates to formulations of the compositions and methods disclosed herein. In some embodiments, the formulation can be in the form of a single package formulation including both (a) a herbicide of formula I or an agriculturally acceptable salt thereof and (b) a safener or an agriculturally acceptable salt or ester thereof. In some embodiments, the formulation can be in the form of a single package formulation including both (a) and (b) and further including at least one additive. In some embodiments, the formulation can be in the form of a two-package formulation, wherein one package contains (a) and optionally at least one additive while the other package contains (b) and optionally at least one additive. In some embodiments of the two-package formulation, the formulation including (a) and optionally at least one additive and the formulation including (b) and optionally at least one additive are mixed before application and then applied simultaneously. In some embodiments, the mixing is performed as a tank mix (i.e., the formulations are mixed immediately before or upon dilution with water). In some embodiments, the formulation including (a) and the formulation including (b) are not mixed but are applied sequentially (in succession), for example, immediately or within 1 hour, within 2 hours, within 4 hours, within 8 hours, within 16 hours, within 24 hours, or within 2 days of each other.

In some embodiments, the formulation of (a) and (b) is present in suspended, emulsified, or dissolved form. Exemplary formulations include, but are not limited to, aqueous solutions, powders, suspensions, also highly-concentrated aqueous, oily or other suspensions or dispersions, aqueous emulsions, aqueous microemulsions, aqueous suspo-emulsions, oil dispersions, pastes, dusts, and materials for spreading or granules. In some examples, the formulation of (a) and (b) is an aqueous suspension concentrate. In some examples, the formulation of (a) and (b) is a water-soluble granule.

The compositions and methods disclosed herein can also be mixed with or applied with an additive. In some embodiments, the additive can be diluted in water or can be concentrated. In some embodiments, the additive is added sequentially. In some embodiments, the additive is added simultaneously. In some embodiments, the additive is premixed with the herbicide or an agriculturally acceptable salt thereof. In some embodiments, the additive is premixed with the safener or an agriculturally acceptable salt or ester thereof. In some embodiments, the additive is premixed with the herbicide or an agriculturally acceptable salt or ester thereof and the safener or an agriculturally acceptable salt or ester thereof.

In some embodiments, the additive includes an additional pesticide. Exemplary additional herbicides include, but are not limited to: 4-CPA; 4-CPB; 4-CPP; 2,4-D; 2,4-DB; 3,4-DA; 3,4-DB; 2,4-DEB; 2,4-DEP; 3,4-DP; 2,3,6-TBA; 2,4,5-T; 2,4,5-TB; acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, 4-aminopicolinic acid based herbicides, such as halauxifen, florpyrauxifen, and those described in U.S. Pat. Nos. 7,314,849 and 7,432,227 to Balko, et al., 4-amino-6-(heterocyclic)picolinates and 6-amino-2-(heterocyclic)pyrimidine-4-carboxylates, such as those described in U.S. Published Application No. 2014/0274695, aminopyralid, amiprofos, aminotriazole, amitrole, ammonium sulfamate, ammonium thiocyanate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron, bensulide, benthiocarb, bentazon, benzadox, benzfendizone, benzipram, benzobicyclon, benzofenap, benzofluor, benzoylprop, benzthiazuron, bicyclopyrone, bifenox, bilanafos, bispyribac, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, chlorprocarb, carfentrazone, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlormequat, chlorimuron, chlornitrofen, chloropon, chlorotoluron, chloroxuron, chloroxynil, chlorpropham, chlorsulfuron, chlorthal, chlorthiamid, chlortoluron, cinidon, cinmethylin, cisanilide, clethodim, cliodinate, clodinafop, clofop, clomazone, clomeprop, cloprop, cloproxydim, clopyralid, cloransulam, CMA, copper sulfate, CPMF, CPPC, credazine, cresol, cumyluron, cyanatryn, cyanazine, cycloate, cyclopyralid, cyclopyrimorate, cyclosulfamuron, cycloxydim, cycluron, cyhalofop, cyperquat, cyprazine, cyprazole, cypromid, daimuron, dalapon, dazomet, delachlor, desmedipham, desmetryn, di-allate, dicamba, dichlobenil, dichloralurea, dichlormate, dichlorprop, diclofop, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethbenzamide, ethametsulfuron, ethidimuron, ethiolate, ethobenzamid, etobenzamid, ethofumesate, ethoxyfen, ethoxysulfuron, etinofen, etnipromid, etobenzanid, EXD, fenasulam, fenoprop, fenoxaprop, fenoxasulfone, fenquinotrione, fenteracol, fenthiaprop, fentrazamide, fenuron, ferrous sulfate, flamprop, flazasulfuron, florasulam, fluazifop, fluazolate, flucarbazone, flucetosulfuron, fluchloralin, flufenacet, flufenican, flufenpyr, flumetsulam, flumezin, flumiclorac, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, flurochloridone, fluroxypyr, flurtamone, fluthiacet, fomesafen, foramsulfuron, fosamine, fumiclorac, furyloxyfen, gibberellic acid, glufosinate, glyphosate, halosafen, halosulfuron, haloxydine, haloxyfop, hexachloroacetone, hexaflurate, hexazinone, imazamethabenz, imazamox, imazapic, imazapyr, imazaquin, imazethapyr, imazapic, imazosulfuron, indanofan, indaziflam, iodobonil, iodomethane, iodosulfuron, iofensulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lancotrione, lactofen, lenacil, linuron, MAA, MAMA, MCPA, MCPA amines, MCPB, mecoprop, medinoterb, mefenacet, mefluidide, mesoprazine, mesosulfuron, mesotrione, metam, metamifop, metamitron, metazosulfuron, metazachlor, metflurazon, methabenzthiazuron, methalpropalin, methazole, methiobencarb, methiozolin, methiuron, methometon, methoprotryne, methyl bromide, 1-methylcyclopropene, methyl isothiocyanate, methyldymron, metobenzuron, metobromuron, metolachlor, metosulam, metoxuron, metribuzin, metsulfuron, molinate, monalide, monisouron, monochloroacetic acid, monolinuron, monuron, morfamquat, MSMA, 1-naphthaleneacetic acid, naproanilide, napropamide, napropamide-M, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxasulfuron, oxaziclomefone, oxyfluorfen, paraflufen, parafluron, paraquat, pebulate, pelargonic acid, pendimethalin, penoxsulam, pentachlorophenol, pentanochlor, pentoxazone, perfluidone, pethoxamid, phenisopham, phenmedipham, phenobenzuron, phenylmercury acetate, picloram, picolinafen, pinoxaden, piperophos, potassium arsenite, potassium azide, potassium cyanate, pretilachlor, primisulfuron, procyazine, prodiamine, profluazol, profluralin, profoxydim, proglinazine, prohexadione, prometon, prometryn, pronamide, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen, pyrasulfotole, pyrazogyl, pyrazolynate, pyrazosulfuron, pyrazoxyfen, pyribenzoxim, pyributicarb, pyriclor, pyridafol, pyridate, pyriftalid, pyrimisulfan, pyrithiobac, pyroxasulfone, pyroxsulam, quinclorac, quinmerac, quinoclamine, quinonamid, quizalofop, rhodethanil, rimsulfuron, saflufenacil, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosate, sulfosulfuron, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiameturon, thiazafluron, thiazopyr, thidiazimin, thidiazuron, thiencarbazone, thifensulfuron, thiobencarb, tiafenacil, tiocarbazil, tioclorim, topramezone, tolpyralate, tralkoxydim, tri-allate, triafamone, triasulfuron, triaziflam, tribenuron, tricamba, triclopyr, triclopyr amines, tridiphane, trietazine, trifloxysulfuron, trifludimoxazin, trifluralin, triflusulfuron, trifop, trifopsime, trihydroxytriazine, trimeturon, tripropindan, tritac tritosulfuron, vernolate, xylachlor, and salts, esters, optically active isomers, and mixtures thereof. In some embodiments, the additional pesticide includes one or more pesticides selected from aminocyclopyrachlor, aminopyralid, atrazine, bromoxynil, chlorotoluron, clodinafop, clopyralid, cyanazine, 2,4-D, dicamba, dimethenamid, flufenacet, flupyrsulfuron, fluroxypyr, flurtamone, glyphosate, glufosinate, imazamox, imazapyr, imazapic, imazaquin, imazethapyr, imazamethabenz, isoproturon, MCPA, penoxsulam, picloram, picolinafen, pinoxaden, propanil, pyroxsulam, terbuthylazine, triclopyr, trifluralin, and agriculturally acceptable salts or esters or mixtures thereof.

In some embodiments, the additive includes an agriculturally acceptable adjuvant. Exemplary agriculturally acceptable adjuvants include, but are not limited to, antifreeze agents, antifoam agents, compatibilizing agents, sequestering agents, neutralizing agents and buffers, corrosion inhibitors, colorants, odorants, penetration aids, wetting agents, spreading agents, dispersing agents, thickening agents, freeze point depressants, antimicrobial agents, crop oils, adhesives (for instance, for use in seed formulations), surfactants, protective colloids, emulsifiers, tackifiers, and mixtures thereof.

Exemplary agriculturally acceptable adjuvants include, but are not limited to, crop oil concentrate (mineral oil (85%)+emulsifiers (15%)); nonylphenol ethoxylate; benzylcocoalkyldimethy quaternary ammonium salt; blend of petroleum hydrocarbon, alkyl esters, organic acid, and anionic surfactant; C₉-C₁₁ alkylpolyglycoside; phosphate alcohol ethoxylate; natural primary alcohol (C₁₂-C₁₆) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8 EO); tallow amine ethoxylate (15 EO); and PEG(400) dioleate-99.

Exemplary surfactants (e.g., wetting agents, dispersants, and emulsifiers) include, but are not limited to, the alkali metal salts, alkaline earth metal salts and ammonium salts of aromatic sulfonic acids, for example lignosulfonic acids, phenolsulfonic acids, naphthalenesulfonic acids, and dibutylnaphthalenesulfonic acid, and of fatty acids, alkyl- and alkylarylsulfonates, alkyl sulfates, lauryl ether sulfates and fatty alcohol sulfates, and salts of sulfated hexa-, hepta- and octadecanols, and also of fatty alcohol glycol ethers, condensates of sulfonated naphthalene and its derivatives with formaldehyde, condensates of naphthalene or of the naphthalene sulfonic acids with phenol and formaldehyde, polyoxyethylene octylphenol ether, ethoxylated isooctyl-, octyl- or nonylphenol, alkylphenyl or tributylphenyl polyglycol ether, alkyl aryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors and proteins, denatured proteins, polysaccharides (e.g., methylcellulose), hydrophobically modified starches, polyvinyl alcohol, polycarboxylates, polyalkoxylates, polyvinyl amine, polyethyleneimine, polyvinylpyrrolidone and copolymers thereof.

Exemplary thickeners include, but are not limited to, polysaccharides, such as xanthan gum, and organic and inorganic sheet minerals, and mixtures thereof.

Exemplary antifoam agents include, but are not limited to, silicone emulsions, long-chain alcohols, fatty acids, salts of fatty acids, organofluorine compounds, and mixtures thereof.

Exemplary antimicrobial agents include, but are not limited to, bactericides based on dichlorophen and benzyl alcohol hemiformal, and isothiazolinone derivatives, such as alkylisothiazolinones and benzisothiazolinones, and mixtures thereof.

Exemplary antifreeze agents, include, but are not limited to ethylene glycol, propylene glycol, urea, glycerol, and mixtures thereof.

Exemplary colorants include, but are not limited to, the dyes known under the names Rhodamine B, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108, and mixtures thereof.

Exemplary adhesives include, but are not limited to, polyvinylpyrrolidone, polyvinyl acetate, polyvinyl alcohol, tylose, and mixtures thereof.

In some embodiments, the additive includes a carrier. In some embodiments, the additive includes a liquid or solid carrier. In some embodiments, the additive includes an organic or inorganic carrier. Exemplary liquid carriers include, but are not limited to, petroleum fractions or hydrocarbons such as mineral oil, aromatic solvents, paraffinic oils, and the like or less, vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like or less, esters of the above vegetable oils or less, esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like or less, esters of mono, di and polycarboxylic acids and the like, toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like, and water as well as mixtures thereof. Exemplary solid carriers include, but are not limited to, silicas, silica gels, silicates, talc, kaolin, limestone, lime, chalk, bole, loess, clay, dolomite, diatomaceous earth, calcium sulfate, magnesium sulfate, magnesium oxide, ground synthetic materials, pyrophyllite clay, attapulgus clay, kieselguhr, calcium carbonate, bentonite clay, Fuller's earth, cottonseed hulls, wheat flour, soybean flour, pumice, wood flour, walnut shell flour, lignin, ammonium sulfate, ammonium phosphate, ammonium nitrate, ureas, cereal meal, tree bark meal, wood meal and nutshell meal, cellulose powders, and mixtures thereof.

Methods of Application

The compositions disclosed herein can be applied in any known technique for applying herbicides. Exemplary application techniques include, but are not limited to, spraying, atomizing, dusting, spreading, or direct application into water (in-water). The method of application can vary depending on the intended purpose. In some embodiments, the method of application can be chosen to ensure the finest possible distribution of the compositions disclosed herein.

In some embodiments, a method of controlling undesirable vegetation which comprises contacting the vegetation or the locus thereof with or applying to the soil or water to limit the emergence or growth of vegetation the compositions is disclosed herein.

The compositions disclosed herein can be applied pre-emergence (before the emergence of undesirable vegetation) or post-emergence (i.e., during and/or after emergence of the undesirable vegetation). In some embodiments, the composition is applied post-emergence to the undesirable vegetation. In some embodiments, the herbicide and safener are applied simultaneously.

When the compositions are used in crops, the compositions can be applied after seeding and before or after the emergence of the crop plants. In some embodiments, the compositions disclosed herein show good crop tolerance even when the crop has already emerged and can be applied during or after the emergence of the crop plants. In some embodiments, when the compositions are used in crops, the compositions can be applied before seeding of the crop plants.

In some embodiments, the compositions disclosed herein are applied to vegetation or an area adjacent the vegetation or applying to soil or water to limit the emergence or growth of vegetation by spraying (e.g., foliar spraying). In some embodiments, the spraying techniques use, for example, water as carrier and spray volume rates of from 2 liters per hectare (L/ha) to 2000 L/ha (e.g., from 10-1000 L/ha or from 50-500 L/ha). In some embodiments, the compositions disclosed herein are applied by the low-volume or the ultra-low-volume method, wherein the application is in the form of micro granules. In some embodiments, wherein the compositions disclosed herein are less well tolerated by certain crop plants, the compositions can be applied with the aid of the spray apparatus in such a way that they come into little contact, if any, with the leaves of the sensitive crop plants while reaching the leaves of undesirable vegetation that grows underneath or on the bare soil (e.g., post-directed or lay-by). In some embodiments, the compositions disclosed herein can be applied as dry formulations (e.g., granules, WDGs, etc.) into water.

In some embodiments, wherein the undesirable vegetation is treated post-emergence, the compositions disclosed herein are applied by foliar application. In some embodiments, herbicidal activity is exhibited by the compounds of the mixture when they are applied directly to the plant or to the locus of the plant at any stage of growth or before planting or emergence. The effect observed can depend upon the type of undesirable vegetation to be controlled, the stage of growth of the undesirable vegetation, the application parameters of dilution and spray drop size, the particle size of solid components, the environmental conditions at the time of use, the specific compound employed, the specific adjuvants and carriers employed, the soil type, and the like, as well as the amount of chemical applied. In some embodiments, these and other factors can be adjusted to promote non-selective or selective herbicidal action.

The compositions and methods disclosed herein can be used to control undesired vegetation in a variety of crop and non-crop applications. In some embodiments, the compositions and methods disclosed herein can be used for controlling undesired vegetation in crops. Exemplary crops include, but are not limited to, wheat, barley, triticale, rye, teff, oats, corn, sorghum, rice, sugarcane and pasture grasses. In some embodiments, the crops are cereal crops. In some embodiments, the cereal crops are spring wheat, winter wheat, durum wheat, spring barley, or a combination thereof.

In some embodiments, the compositions and methods disclosed herein can be used for controlling undesired vegetation in non-crop areas. Exemplary non-crop areas include, but are not limited to, turf, pasture, fallow, wildlife management areas, or rangeland. In some embodiments, the compositions and methods disclosed herein can be used in industrial vegetation management (IVM) or for utility, pipeline, roadside, and railroad rights-of-way applications. In some embodiments, the compositions and methods disclosed herein can also be used in forestry (e.g., for site preparation or for combating undesirable vegetation in plantation forests or Coniferae trees). In some embodiments, the compositions and methods disclosed herein can be used to control undesirable vegetation in conservation reserve program (CRP) lands, aquatics, trees, vines, grasslands, and grasses grown for seeds. In some embodiments, the compositions and methods disclosed herein can be used on lawns (e.g., residential, industrial, and institutional), golf courses, parks, cemeteries, athletic fields, and sod farms.

The compositions and methods disclosed herein can also be used in crop plants that are resistant to, for instance, herbicides, pathogens, and/or insects. The compositions and methods described herein may be used to control undesirable vegetation in glyphosate-tolerant-, 5-enolpyruvylshikimate-3-phosphate (EPSP) synthase inhibitor-tolerant-, glufosinate-tolerant-, glutamine synthetase inhibitor-tolerant-, dicamba-tolerant-, phenoxy auxin-tolerant-, pyridyloxy auxin-tolerant-, auxin-tolerant-, synthetic auxin-tolerant-, auxin transport inhibitor-tolerant-, aryloxyphenoxypropionate-tolerant-, cyclohexanedione-tolerant-, phenylpyrazoline-tolerant-, acetyl CoA carboxylase (ACCase) inhibitor-tolerant-, imidazolinone-tolerant-, sulfonylurea-tolerant-, pyrimidinylthiobenzoate-tolerant-, triazolopyrimidine-tolerant-, sulfonylaminocarbonyltriazolinone-tolerant-, acetolactate synthase (ALS) or acetohydroxy acid synthase (AHAS) inhibitor-tolerant-, 4-hydroxyphenyl-pyruvate dioxygenase (HPPD) inhibitor-tolerant-, phytoene desaturase inhibitor-tolerant-, carotenoid biosynthesis inhibitor-tolerant-, protoporphyrinogen oxidase (PPO) inhibitor-tolerant-, cellulose biosynthesis inhibitor-tolerant-, mitosis inhibitor-tolerant-, microtubule inhibitor-tolerant-, very long chain fatty acid inhibitor-tolerant-, fatty acid and lipid biosynthesis inhibitor-tolerant-, photosystem I inhibitor-tolerant-, photosystem II inhibitor-tolerant-, triazine-tolerant- and bromoxynil-tolerant-crops (such as, but not limited to, soybean, cotton, canola/oilseed rape, rice, cereals, corn, sorghum, sunflower, sugar beet, sugarcane, turf, etc.), for example, in conjunction with glyphosate, EPSP synthase inhibitors, glufosinate, glutamine synthetase inhibitors, dicamba, phenoxy auxins, pyridyloxy auxins, auxins, synthetic auxins, auxin transport inhibitors, aryloxyphenoxypropionates, cyclohexanediones, phenylpyrazolines, ACCase inhibitors, imidazolinones, sulfonylureas, pyrimidinylthiobenzoates, triazolopyrimidines, sulfonylaminocarbonyltriazolinones, ALS or AHAS inhibitors, HPPD inhibitors, phytoene desaturase inhibitors, carotenoid biosynthesis inhibitors, PPO inhibitors, cellulose biosynthesis inhibitors, mitosis inhibitors, microtubule inhibitors, very long chain fatty acid inhibitors, fatty acid and lipid biosynthesis inhibitors, photosystem I inhibitors, photosystem II inhibitors, triazines, and bromoxynil. The compositions and methods may be used in controlling undesirable vegetation in crops possessing multiple or stacked traits conferring tolerance to multiple chemistries and/or inhibitors of multiple modes of action. In some embodiments, the compositions described herein are used in combination with herbicides that are selective for the crop being treated and which complement the spectrum of weeds controlled by these compounds at the application rate employed. In some embodiments, the compositions described herein and other complementary herbicides are applied at the same time, either as a combination formulation or as a tank mix, or sequentially.

In some embodiments, the compositions and methods may be used in controlling undesirable vegetation in phenoxy acid tolerant crops, wherein the phenoxy acid tolerant crops have tolerance conferred by an AAD12 gene.

In some examples, the compositions and methods may be used in controlling undesirable vegetation that is resistant to auxinic herbicides.

The compositions and methods may be used in controlling undesirable vegetation in crops possessing agronomic stress tolerance (including but not limited to drought, cold, heat, salt, water, nutrient, fertility, pH), pest tolerance (including but not limited to insects, fungi and pathogens) and crop improvement traits (including but not limited to yield; protein, carbohydrate, or oil content; protein, carbohydrate, or oil composition; plant stature and plant architecture).

The herbicidal compositions prepared as disclosed herein are effective against a variety of types of undesirable vegetation. In some embodiments, the compositions disclosed herein can be used for controlling broadleaf weeds. Exemplary broadleaf weeds include, but are not limited to, Polygonum species such as wild buckwheat (Polygonum convolvolus), Amaranthus species such as pigweed (Amaranthus retroflexus), Chenopodium species such as common lambsquarters (Chenopodium album L.), Sida species such as prickly sida (Sida spinosa L.), Ambrosia species such as common ragweed (Ambrosia artemisiifolia), Acanthospermum species, Anthemis species, Atriplex species, Brassica species, Cirsium species such as Canada thistle (Cirsium arvense), Convolvulus species, Conyza species, such as horseweed (Conyza canadensis), Cassia species, Commelina species, Datura species, Euphorbia species, Geranium species, Galinsoga species, Ipomea species such as morning-glory, Lamium species, Malva species, Matricaria species such as wild chamomile (Matricaria chamomilla), Prosopis species, Rumex species, Sisymbrium species, Solanum species, Trifolium species, Xanthium species, Veronica species, Viola species such as wild pansy (Viola tricolor), common chickweed (Stellaria media), velvetleaf (Abutilon theophrasti), Hemp sesbania (Sesbania exaltata Cory), Anoda cristata, Bidens pilosa, Brassica kaber, shepherd's purse (Capsella bursa-pastoris), Centaurea cyanus, Galeopsis tetrahit, Galium aparine, Helianthus annuus, Desmodium tortuosum, kochia (Bassia scoparia), Medicago arabica, Mercurialis annua, Myosotis arvensis, Papaver rhoeas, Raphanus raphanistrum, prickly stalwort (Salsola kali), Russian thistle (Salsola iberica), wild mustard (Sinapis arvensis), Sonchus arvensis, Thlaspi arvense, Tagetes minuta, Richardia brasiliensis, Plantago major, Plantago lanceolata, bird's-eye speedwell and speedwell. In some embodiments, the undesirable vegetation includes kochia (KCHSC, Bassia scoparia), Canada thistle (CIRAR, Cirsuim arvensis), wild pansy (VIOTR, Viola tricolor), lambsquarters (CHEAL, Chenopodium album), wild mustard (SINAR, Sinapis arvensis), wild chamomile (MATCH, Matricaria chamomilla), shepherd's purse (CAPBP, Capsella bura-pastoris), pigweed (AMARE, Amaranthis retroflexus), or a combination thereof.

The pyridine carboxylic acid herbicide described herein can be used in any amount sufficient to induce a herbicidal effect. In some embodiments, the herbicide is applied to vegetation or an area adjacent the vegetation or applied to soil or water to limit the emergence or growth of vegetation in an amount of at least 4 grams acid equivalent per hectare (g ae/ha) (e.g., at least 5 g ae/ha, at least 6 g ae/ha, at least 7 g ae/ha, at least 8 g ae/ha, at least 9 g ae/ha, at least 10 g ae/ha, at least 15 g ae/ha, at least 20 g ae/ha, at least 25 g ae/ha, at least 30 g ae/ha, at least 35 g ae/ha, at least 40 g ae/ha, at least 45 g ae/ha, at least 50 g ae/ha, at least 55 g ae/ha, at least 60 g ae/ha, at least 65 g ae/ha, at least 70 g ae/ha, at least 75 g ae/ha, at least 80 g ae/ha, at least 85 g ae/ha, at least 90 g ae/ha, or at least 95 g ae/ha). In some embodiments, the herbicide is applied to vegetation or an area adjacent the vegetation or applied to soil or water to limit the emergence or growth of vegetation in an amount of 100 g ae/ha or less (e.g., 95 g ae/ha or less, 90 g ae/ha or less, 85 g ae/ha or less, 80 g ae/ha or less, 75 g ae/ha or less, 70 g ae/ha or less, 65 g ae/ha or less, 60 g ae/ha or less, 55 g ae/ha or less, 50 g ae/ha or less, 45 g ae/ha or less, 40 g ae/ha or less, 35 g ae/ha or less, 30 g ae/ha or less, 25 g ae/ha or less, 20 g ae/ha or less, 15 g ae/ha or less, or 10 g ae/ha or less). In some embodiments, the herbicide is applied to vegetation or an area adjacent the vegetation or applied to soil or water to limit the emergence or growth of vegetation in an amount of 4-100 g ae/ha (e.g., 10-100 g ae/ha, 4-90 g ae/ha, 5-80 g ae/ha, 10-70 g ae/ha, 20-60 g ae/ha, or 25-55 g ae/ha).

The safener or agriculturally acceptable salt or ester thereof described herein can be used in an amount sufficient to induce a safening effect. In some embodiments, the safener or agriculturally acceptable salt or ester thereof is applied to vegetation or an area adjacent the vegetation or applied to soil or in water in an amount of at least 5 grams active ingredient per hectare (g ai/ha) (e.g., at least 10 g ai/ha, at least 15 g ai/ha, at least 20 g ai/ha, at least 25 g ai/ha, at least 30 g ai/ha, at least 35 g ai/ha, at least 40 g ai/ha, at least 45 g ai/ha, at least 50 g ai/ha, at least 55 g ai/ha, at least 60 g ai/ha, at least 65 g ai/ha, at least 70 g ai/ha, at least 75 g ai/ha, at least 80 g ai/ha, at least 85 g ai/ha, at least 90 g ai/ha, at least 95 g ai/ha, at least 100 g ai/ha, at least 105 g ai/ha, at least 110 g ai/ha, at least 115 g ai/ha, at least 120 g ai/ha, at least 125 g ai/ha, at least 130 g ai/ha, at least 135 g ai/ha, at least 140 g ai/ha, at least 145 g ai/ha, at least 150 g ai/ha, at least 155 g ai/ha, at least 160 g ai/ha, at least 165 g ai/ha, at least 170 g ai/ha, at least 175 g ai/ha, at least 180 g ai/ha, at least 185 g ai/ha, at least 190 g ai/ha, or at least 195 g ai/ha). In some embodiments, the safener or agriculturally acceptable salt or ester thereof is applied to vegetation or an area adjacent the vegetation or applied to soil or in water in an amount of 200 g ai/ha or less (e.g., 195 g ai/ha or less, 190 g ai/ha or less, 185 g ai/ha or less, 180 g ai/ha or less, 175 g ai/ha or less, 170 g ai/ha or less, 165 g ai/ha or less, 160 g ai/ha or less, 155 g ai/ha or less, 150 g ai/ha or less, 145 g ai/ha or less, 140 g ai/ha or less, 135 g ai/ha or less, 130 g ai/ha or less, 125 g ai/ha or less, 120 g ai/ha or less, 115 g ai/ha or less, 110 g ai/ha or less, 105 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, 20 g ai/ha or less, 15 g ai/ha or less, or 10 g ai/ha or less). In some embodiments, the safener or agriculturally acceptable salt or ester thereof is applied to vegetation or an area adjacent the vegetation or applied to soil or in water in an amount of 5-200 g ai/ha (e.g., 5-175 g ai/ha, 5-150 g ai/ha, 5-125 g ai/ha, 5-100 g ai/ha, 5-90 g ai/ha, 10-80 g ai/ha, 20-80 g ai/ha, 20-70 g ai/ha, 30-60 g ai/ha, or 40-50 g ai/ha).

By way of non-limiting illustration, examples of certain embodiments of the present disclosure are given below. Parts and percentages are on a per weight basis unless otherwise indicated.

### Examples

The herbicide of formula I-G-A:

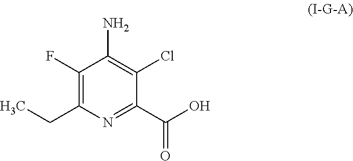

was combined with benoxacor, 2-CBSU, dichlormid, dicyclonon, fenchlorazole, fenclorim, or naphthalic anhydride, and applied to spring wheat (TRZAS) and spring barley (HORVS) and the phytotoxicity of the herbicidal composition was measured. The results for herbicide I-G-A with benoxacor, 2-CBSU, dichlormid, dicyclonon, fenchlorazole, fenclorim, and naphthalic anhydride are summarized in Tables 1-6 and Table 9, respectively.

The herbicide of formula I-G-A was combined with isoxadifen-ethyl or mefenpyr-diethyl, and applied to spring wheat (TRZAS) and spring barley (HORVS) and the phytotoxicity of the herbicidal composition was measured. In addition, the efficacy of the herbicidal composition on wild mustard (SINAR), wild chamomile (MATCH), wild pansy (VIOTR), shepherd's purse (CAPBP), kochia (KCHSC), lambsquarters (CHEAL), pigweed (AMARE), and Canada thistle (CIRAR) was evaluated. The results for herbicide I-G-A with isoxadifen-ethyl and mefenpyr-diethyl are summarized in Table 7 and Table 8, respectively.

Seeds of the desired test plant species were planted in Sun Gro MetroMix® 360 planting mixture, which typically has a pH of 6.0 to 6.8 and an organic matter content of about 30 percent, in plastic pots with a surface area of 103.2 square centimeters (cm²). When required to ensure good germination and healthy plants, a fungicide treatment and/or other chemical or physical treatment was applied. The plants were grown for 7-36 days (d) in a greenhouse with an approximate 14-hour (h) photoperiod which was maintained at about 18° C. during the day and 17° C. during the night. Nutrients and water were added on a regular basis and supplemental lighting was provided with overhead metal halide 1000-Watt lamps as necessary. The plants were employed for testing when they reached the second or third true leaf stage.

Weighed amounts of technical material were dissolved in a volume of 97:3 volume per volume (v/v) acetone/dimethyl sulfoxide (DMSO) to stock solutions. If the experimental compound did not dissolve readily, the mixture was warmed and/or sonicated. The concentrated stock solutions were diluted with an aqueous mixture of 1.5% v/v of Agri-dex crop oil concentrate to provide the appropriate application rates. Compound requirements are based upon a 12 milliliter (mL) application volume at a rate of 187 liters per hectare (L/ha). Stock solutions of the safeners were prepared following the same procedure. Spray solutions of the safeners and experimental compound mixtures were prepared by adding the stock solutions to the appropriate amount of dilution solution to form a 12 mL spray solution in two-way combinations. Formulated compounds were applied to the plant material with an overhead Mandel track sprayer equipped with 8002E nozzles calibrated to deliver 187 L/ha over an application area of 0.503 square meters (m²) at a spray height of 18 inches (43 centimeters (cm)) above average plant canopy. Control plants were sprayed in the same manner with the solvent blank.

The treated plants and control plants were placed in a greenhouse as described above and watered by sub-irrigation to prevent wash-off of the test compounds. After 20-22 d, the condition of the test plants as compared with that of the control plants was determined visually and scored on a scale of 0 to 100 percent where 0 corresponds to no injury and 100 corresponds to complete kill. Colby's equation was used to determine the herbicidal effects expected from the mixtures.

TABLE 1
Effect (% visual injury) of the herbicide of formula (I-G-A) in
combination with benoxacor on cereals.

| Herbicide | Benoxacor | TRZAW | | | HORVS | | |
|---|---|---|---|---|---|---|---|
| (g ae/ha) | (g ai/ha) | Obs | Exp | Δ | Obs | Exp | Δ |
| 20 | 0 | 25 | — | — | 13 | — | — |
| 0 | 20 | 0 | — | — | 0 | — | — |
| 0 | 40 | 0 | — | — | 0 | — | — |
| 0 | 80 | 0 | — | — | 0 | — | — |
| 20 | 20 | 15 | 25 | −10 | 5 | 13 | −8 |
| 20 | 40 | 12 | 25 | −13 | 5 | 13 | −8 |
| 20 | 80 | 10 | 25 | −15 | 7 | 13 | −7 |

g ae/ha = grams acid equivalent per hectare
g ai/ha = grams active ingredient per hectare
TRZAW = Triticum aestivum (winter wheat)
HORVS = Hordeum vulgare (spring barley)

TABLE 2
Effect (% visual injury) of the herbicide of formula (I-G-A) in
combination with 2-CBSU on cereals.

| Herbicide | 2-CBSU | TRZAW | | | HORVS | | |
|---|---|---|---|---|---|---|---|
| (g ae/ha) | (g ai/ha) | Obs | Exp | Δ | Obs | Exp | Δ |
| 20 | 0 | 25 | — | — | 13 | — | — |
| 0 | 20 | 0 | — | — | 0 | — | — |
| 0 | 40 | 0 | — | — | 0 | — | — |
| 0 | 80 | 0 | — | — | 0 | — | — |
| 20 | 20 | 12 | 25 | −13 | 3 | 13 | −10 |
| 20 | 40 | 12 | 25 | −13 | 7 | 13 | −7 |
| 20 | 80 | 8 | 25 | −17 | 7 | 13 | −7 |

g ae/ha = grams acid equivalent per hectare
g ai/ha = grams active ingredient per hectare
TRZAW = Triticum aestivum (winter wheat)
HORVS = Hordeum vulgare (spring barley)

TABLE 3
Effect (% visual injury) of the herbicide of formula (I-G-A) in
combination with dichlormid on cereals.

| Herbicide | Dichlormid | TRZAW | | | HORVS | | |
|---|---|---|---|---|---|---|---|
| (g ae/ha) | (g ai/ha) | Obs | Exp | Δ | Obs | Exp | Δ |
| 20 | 0 | 25 | — | — | 13 | — | — |
| 0 | 20 | 0 | — | — | 0 | — | — |
| 0 | 40 | 0 | — | — | 0 | — | — |
| 0 | 80 | 0 | — | — | 0 | — | — |
| 20 | 20 | 7 | 25 | −18 | 3 | 13 | −10 |
| 20 | 40 | 3 | 25 | −22 | 0 | 13 | −13 |
| 20 | 80 | 7 | 25 | −18 | 7 | 13 | −7 |

g ae/ha = grams acid equivalent per hectare
g ai/ha = grams active ingredient per hectare
TRZAW = Triticum aestivum (winter wheat)
HORVS = Hordeum vulgare (spring barley)

TABLE 4
Effect (% visual injury) of the herbicide of formula (I-G-A) in
combination with dicyclonon on cereals.

| Herbicide | Dicyclonon | TRZAW | | | HORVS | | |
|---|---|---|---|---|---|---|---|
| (g ae/ha) | (g ai/ha) | Obs | Exp | Δ | Obs | Exp | Δ |
| 20 | 0 | 25 | — | — | 13 | — | — |
| 0 | 20 | 0 | — | — | 0 | — | — |
| 0 | 40 | 0 | — | — | 0 | — | — |
| 0 | 80 | 0 | — | — | 0 | — | — |
| 20 | 20 | 7 | 25 | −18 | 7 | 13 | −7 |
| 20 | 40 | 3 | 25 | −22 | 7 | 13 | −7 |
| 20 | 80 | 10 | 25 | −15 | 7 | 13 | −7 |

g ae/ha = grams acid equivalent per hectare
g ai/ha = grams active ingredient per hectare
TRZAW = Triticum aestivum (winter wheat)
HORVS = Hordeum vulgare (spring barley)

TABLE 5
Effect (% visual injury) of the herbicide of formula (I-G-A) in
combination with fenchlorazole on cereals.

| Herbicide | Fenchlorazole | TRZAW | | | HORVS | | |
|---|---|---|---|---|---|---|---|
| (g ae/ha) | (g ai/ha) | Obs | Exp | Δ | Obs | Exp | Δ |
| 20 | 0 | 25 | — | — | 13 | — | — |
| 0 | 20 | 0 | — | — | 0 | — | — |
| 0 | 40 | 0 | — | — | 0 | — | — |
| 0 | 80 | 0 | — | — | 0 | — | — |
| 20 | 20 | 0 | 25 | −25 | 0 | 13 | −13 |
| 20 | 40 | 0 | 25 | −25 | 0 | 13 | −13 |
| 20 | 80 | 0 | 25 | −25 | 0 | 13 | −13 |

g ae/ha = grams acid equivalent per hectare
g ai/ha = grams active ingredient per hectare
TRZAW = Triticum aestivum (winter wheat)
HORVS = Hordeum vulgare (spring barley)

TABLE 6
Effect (% visual injury) of the herbicide of formula (I-G-A) in
combination with fenclorim on cereals.

| Herbicide | Fenclorim | TRZAW | | | HORVS | | |
|---|---|---|---|---|---|---|---|
| (g ae/ha) | (g ai/ha) | Obs | Exp | Δ | Obs | Exp | Δ |
| 20 | 0 | 25 | — | — | 13 | — | — |
| 0 | 20 | 0 | — | — | 0 | — | — |
| 0 | 40 | 0 | — | — | 0 | — | — |
| 0 | 80 | 0 | — | — | 0 | — | — |
| 20 | 20 | 0 | 25 | −25 | 0 | 13 | −13 |
| 20 | 40 | 0 | 25 | −25 | 0 | 13 | −13 |
| 20 | 80 | 0 | 25 | −25 | 0 | 13 | −13 |

g ae/ha = grams acid equivalent per hectare
g ai/ha = grams active ingredient per hectare
TRZAW = Triticum aestivum (winter wheat)
HORVS = Hordeum vulgare (spring barley)

TABLE 7
Effect (% visual injury) of the herbicide of formula (I-G-A) in
combination with isoxadifen-ethyl on cereals and weeds.

| Application rate | | | | | | | | | | | | | | | | |
|---|---|---|---|---|---|---|---|---|---|---|---|---|---|---|---|---|
| | Isoxadifen- | | | | | | | | | | | | | | | |
| Herbicide | ethyl | TRZAW | | | HORVS | | | SINAR | | | MATCH | | | VIOTR | | |
| (g ae/ha) | (g ai/ha) | Obs | Exp | Δ | Obs | Exp | Δ | Obs | Exp | Δ | Obs | Exp | Δ | Obs | Exp | Δ |
| 20 | 0 | 25 | — | — | 13 | — | — | 97 | — | — | 80 | — | — | 60 | — | — |
| 0 | 20 | 0 | — | — | 0 | — | — | 0 | — | — | 0 | — | — | 0 | — | — |
| 0 | 40 | 0 | — | — | 0 | — | — | 0 | — | — | 0 | — | — | 0 | — | — |
| 0 | 80 | 0 | — | — | 0 | — | — | 0 | — | — | 0 | — | — | 0 | — | — |
| 20 | 20 | 0 | 25 | −25 | 0 | 13 | −13 | 97 | 97 | 0 | 75 | 80 | −5 | 65 | 60 | 5 |
| 20 | 40 | 3 | 25 | −22 | 5 | 13 | −8 | — | — | — | — | — | — | — | — | — |
| 20 | 80 | 3 | 25 | −22 | 3 | 13 | −10 | 97 | 97 | 0 | 60 | 80 | −20 | 60 | 60 | 0 |

| Application rate | | | | | | | | | | | | | | | | |
|---|---|---|---|---|---|---|---|---|---|---|---|---|---|---|---|---|
| | Isoxadifen- | | | | | | | | | | | | | | | |
| Herbicide | ethyl | CAPBP | | | KCHSC | | | CHEAL | | | AMARE | | | CIRAR | | |
| (g ae/ha) | (g ai/ha) | Obs | Exp | Δ | Obs | Exp | Δ | Obs | Exp | Δ | Obs | Exp | Δ | Obs | Exp | Δ |
| 20 | 0 | 100 | — | — | 20 | — | — | 95 | — | — | 20 | — | — | 80 | — | — |
| 0 | 20 | 0 | — | — | 0 | — | — | 0 | — | — | 0 | — | — | 0 | — | — |
| 0 | 40 | 0 | — | — | 0 | — | — | 0 | — | — | 0 | — | — | 0 | — | — |
| 0 | 80 | 0 | — | — | 0 | — | — | 0 | — | — | 0 | — | — | 0 | — | — |
| 20 | 20 | 100 | 100 | 0 | 20 | 20 | 0 | 95 | 95 | 0 | 40 | 20 | 20 | 95 | 80 | 5 |
| 20 | 40 | — | — | — | — | — | — | — | — | — | — | — | — | — | — | — |
| 20 | 80 | 100 | 100 | 0 | 10 | 20 | −10 | 95 | 95 | 0 | 30 | 20 | 10 | 93 | 80 | 13 |

g ae/ha = grams acid equivalent per hectare;
g ai/ha = grams active ingredient per hectare;
TRZAW = Triticum aestivum (winter wheat);
HORVS = Hordeum vulgare (spring barley);
SINAR = Sinapis arvensis (wild mustard);
MATCH = Matricaria recutita (wild chamomile);
VIOTR = Viola tricolor (wild pansy);
CAPBP = Capsella bursa-pastoris (shepherd's purse);
KCHSC = Kochia scoparia (kochia);
CHEAL = Chenopodium album (lambsquarters);
AMARE = Amaranthus retroflexus (pigweed);
CIRAR = Cirsium arvense (Canada thistle)

TABLE 8
Effect (% visual injury) of the herbicide of formula (I-G-A) in
combination with mefenpyr-diethyl on cereal and weeds.

| Application rates | | | | | | | | | | | | | | | | |
|---|---|---|---|---|---|---|---|---|---|---|---|---|---|---|---|---|
| | Mefenpyr- | | | | | | | | | | | | | | | |
| Herbicide | diethyl | TRZAW | | | HORVS | | | SINAR | | | MATCH | | | VIOTR | | |
| (g ae/ha) | (g ai/ha) | Obs | Exp | Δ | Obs | Exp | Δ | Obs | Exp | Δ | Obs | Exp | Δ | Obs | Exp | Δ |
| 20 | 0 | 25 | — | — | 13 | — | — | 97 | — | — | 80 | — | — | 60 | — | — |
| 0 | 20 | 0 | — | — | 0 | — | — | 0 | — | — | 0 | — | — | 0 | — | — |
| 0 | 40 | 0 | — | — | 0 | — | — | 0 | — | — | 0 | — | — | 0 | — | — |
| 0 | 80 | 0 | — | — | 0 | — | — | 0 | — | — | 0 | — | — | 0 | — | — |
| 20 | 20 | 0 | 25 | −25 | 0 | 13 | −13 | 97 | 97 | 0 | 80 | 80 | 0 | 60 | 60 | 0 |
| 20 | 40 | 0 | 25 | −25 | 0 | 13 | −13 | — | — | — | — | — | — | — | — | — |
| 20 | 80 | 0 | 25 | −25 | 0 | 13 | −13 | 97 | 97 | 0 | 80 | 80 | 0 | 60 | 60 | 0 |

| Application rates | | | | | | | | | | | | | | | | |
|---|---|---|---|---|---|---|---|---|---|---|---|---|---|---|---|---|
| | Mefenpyr- | | | | | | | | | | | | | | | |
| Herbicide | diethyl | CAPBP | | | KCHSC | | | CHEAL | | | AMARE | | | CIRAR | | |
| (g ae/ha) | (g ai/ha) | Obs | Exp | Δ | Obs | Exp | Δ | Obs | Exp | Δ | Obs | Exp | Δ | Obs | Exp | Δ |
| 20 | 0 | 100 | — | — | 20 | — | — | 95 | — | — | 20 | — | — | 80 | — | — |
| 0 | 20 | 0 | — | — | 0 | — | — | 0 | — | — | 0 | — | — | 0 | — | — |
| 0 | 40 | 0 | — | — | 0 | — | — | 0 | — | — | 0 | — | — | 0 | — | — |
| 0 | 80 | 0 | — | — | 0 | — | — | 0 | — | — | 0 | — | — | 0 | — | — |
| 20 | 20 | 100 | 100 | 0 | 20 | 20 | 0 | 95 | 95 | 0 | 30 | 20 | 10 | 93 | 80 | 13 |
| 20 | 40 | — | — | — | — | — | — | — | — | — | — | — | — | — | — | — |
| 20 | 80 | 100 | 100 | 0 | 20 | 20 | 0 | 95 | 95 | 0 | 30 | 20 | 10 | 93 | 80 | 13 |

g ae/ha = grams acid equivalent per hectare;
g ai/ha = grams active ingredient per hectare;
TRZAW = Triticum aestivum (winter wheat);
HORVS = Hordeum vulgare (spring barley);
SINAR = Sinapis arvensis (wild mustard);
MATCH = Matricaria recutita (wild chamomile);
VIOTR = Viola tricolor (wild pansy);
CAPBP = Capsella bursa-pastoris (shepherd's purse);
KCHSC = Kochia scoparia (kochia);
CHEAL = Chenopodium album (lambsquarters);
AMARE = Amaranthus retroflexus (pigweed);
CIRAR = Cirsium arvense (Canada thistle)

TABLE 9
Effect (% visual injury) of the herbicide of formula (I-G-A) in
combination with naphthalic anhydride on cereals.

| | Naphthalic | | | | | | |
|---|---|---|---|---|---|---|---|
| Herbicide | anhydride | TRZAW | | | HORVS | | |
| (g ae/ha) | (g ai/ha) | Obs | Exp | Δ | Obs | Exp | Δ |
| 20 | 0 | 25 | — | — | 13 | — | — |
| 0 | 20 | 0 | — | — | 0 | — | — |
| 0 | 40 | 0 | — | — | 0 | — | — |
| 0 | 80 | 0 | — | — | 0 | — | — |
| 20 | 20 | 3 | 25 | −22 | 0 | 13 | −13 |
| 20 | 40 | 3 | 25 | −22 | 0 | 13 | −13 |
| 20 | 80 | 0 | 25 | −23 | 0 | 13 | −13 |

g ae/ha = grams acid equivalent per hectare
g ai/ha = grams active ingredient per hectare
TRZAW = Triticum aestivum (winter wheat)
HORVS = Hordeum vulgare (spring barley)

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

What is claimed is:

1. A method of controlling undesirable vegetation, comprising applying to vegetation or an area adjacent the vegetation or applying to soil or water to limit the emergence or growth of vegetation a herbicidal composition comprising:
(a) a herbicide comprising a compound of the following structure 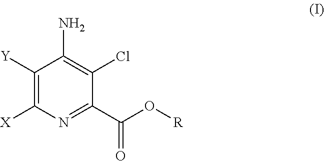
wherein
X represents alkyl, haloalkyl, alkoxy, haloalkoxy, alkylamino, alkenyl, alkynyl, or cycloalkyl;
Y represents hydrogen, alkyl, or halogen;
R represents hydrogen, alkyl, or benzyl; or
an agriculturally acceptable salt thereof; and
(b) a safener, or an agriculturally acceptable salt or ester thereof;
wherein the herbicide is applied in an amount of at least 4 g ae/ha; and
wherein the safener is benoxacor, 2-CBSU, dichlormid, dicyclonon, fenchlorazole, fenclorim, isoxadifen-ethyl, mefenpyr-diethyl, naphthalic anhydride, or a combination thereof.

2. The method of claim 1, wherein the herbicide and the safener are applied simultaneously.

3. The method of claim 1, wherein the herbicide and the safener are applied post-emergence to the undesirable vegetation.

4. The method of claim 1, wherein the herbicide is of the following structure 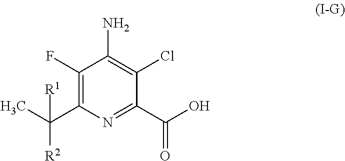
wherein
R¹ and R² independently represent hydrogen or halogen;
or an agriculturally acceptable salt or ester thereof.

5. The method of claim 1, wherein the ratio of the herbicide (in g ae/ha) to the safener (in g ai/ha) is from 1:8 to 2:1.

6. The method of claim 1, wherein the composition does not include a herbicidal active ingredient in addition to (a).

7. The method of claim 1, wherein the composition does not include a safener in addition to (b).

8. The method of claim 1, wherein the undesirable vegetation is controlled in a cereal crop.

9. The method of claim 8, wherein the cereal crops include spring wheat, winter wheat, durum wheat, spring barley, or a combination thereof.

10. The method of claim 1, wherein the undesirable vegetation includes kochia, wild pansy, Canada thistle, lambsquarters, wild mustard, wild chamomile, shepherd's purse, pigweed, or a combination thereof.

11. The method of claim 1, wherein the undesirable vegetation is controlled in crops tolerant to glyphosate, glufosinate, dicamba, phenoxy auxins, pyridyloxy auxins, aryloxyphenoxypropionates, acetyl CoA carboxylase (ACCase) inhibitors, imidazolinones, acetolactate synthase (ALS) inhibitors, 4-hydroxyphenyl-pyruvate dioxygenase (HPPD) inhibitors, protoporphyrinogen oxidase (PPO) inhibitors, triazines, bromoxynil, or combinations thereof.

12. The method of claim 11, wherein the undesirable vegetation is controlled in phenoxy acid tolerant crops and the phenoxy acid tolerant crops have tolerance conferred by an AAD12 gene.

13. The method of claim 1, wherein the undesirable vegetation is resistant to auxinic herbicides.

14. The method of claim 1, wherein the herbicide is provided in an amount of 4 g ae/ha to 100 g ae/ha.

15. The method of claim 1, wherein the safener is provided in an amount of 5 g ai/ha to 200 g ai/ha.

16. A composition for controlling undesirable vegetation in cereals, comprising:
(a) a herbicide comprising a compound of the following structure 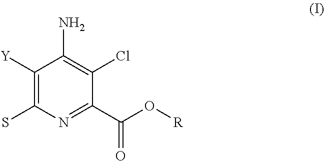
wherein
X represents alkyl, haloalkyl, alkoxy, haloalkoxy, alkylamino, alkenyl, alkynyl, or cycloalkyl;
Y represents hydrogen, alkyl, or halogen;
R represents hydrogen, alkyl, or benzyl; or
an agriculturally acceptable salt thereof; and
(b) a safener, or an agriculturally acceptable salt or ester thereof;
wherein the safener is benoxacor, 2-CBSU, dichlormid, dicyclonon, fenchlorazole, fenclorim, isoxadifen-ethyl, mefenpyr-diethyl, naphthalic anhydride, or a combination thereof; and
wherein the herbicide (in g ae/ha) and the safener (in g ai/ha) are provided in a weight ratio of from 1:8 to 2:1.

17. The composition of claim 16, wherein the herbicide is of the following structure 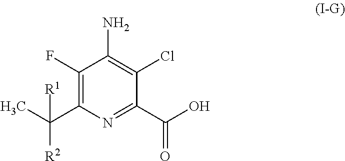
wherein
R¹ and R² independently represent hydrogen or halogen;
or an agriculturally acceptable salt or ester thereof.

18. The composition of claim 16, wherein the ratio of the herbicide (in g ae/ha) to the safener (in g ai/ha) is from 1:4 to 1:1.

19. The composition of claim 16, wherein the composition does not include a herbicidal active ingredient in addition to (a).

20. The composition of claim 16, wherein the composition does not include a safener in addition to (b).
